(19) United States
(12) Patent Application Publication
(10) Pub. No.: US 2024/0400840 A1
(43) Pub. Date: Dec. 5, 2024

(54) QUANTUM DOT COMPOSITE MICROSPHERES, QUANTUM DOT COMPOSITE MICROSPHERE FILMS AND PREPARATION METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventors: Jinyang ZHAO, Shenzhen (CN); Lixuan CHEN, Shenzhen (CN); Xin ZHANG, Shenzhen (CN)

(21) Appl. No.: 18/457,945

(22) Filed: Aug. 29, 2023

(30) Foreign Application Priority Data
Jun. 5, 2023 (CN) 202310659986.2

(51) Int. Cl. C09D 5/22; C09D 7/40; C09D 7/62; C09D 125/06; C09K 11/02; C09K 11/88

(52) U.S. Cl. CPC C09D 5/22; C09D 7/62; C09D 7/67; C09D 7/68; C09D 7/70; C09D 125/06; C09K 11/025; C09K 11/883; B82Y 20/00; B82Y 40/00

(57) ABSTRACT

Disclosed are quantum dot composite microspheres, quantum dot composite microsphere film and preparation method thereof. The quantum dot composite microsphere includes a core, a quantum dot layer adsorbed on a surface of the core, and an outer shell layer coated on the surface of the quantum dot layer, wherein one or more polymer ligands with an ionizable end group are attached to the surface of the outer shell layer. One or more polymer ligands with ionizable end groups are disposed on an outer shell layer of quantum dot composite microspheres. After the quantum dot composite microspheres are dissolved in a solvent, the quantum dot composite microspheres are charged positively or negatively, so that quantum dot composite microspheres are deposited on a positive electrode and a negative electrode during an electrodeposition process, thereby obtaining quantum dot composite microsphere film containing the such quantum dot composite microspheres.

### CROSS-REFERENCE TO RELATED APPLICATION

The present disclosure claims priority to and the benefit of Chinese Patent Application No. 202310659986.2, filed on Jun. 5, 2023, the disclosure of which is incorporated herein by reference in its entirety.

### TECHNICAL FIELD

The present disclosure relates to the field of nano materials, and in particular, to quantum dot composite microspheres, quantum dot composite microsphere films and preparation method thereof.

### BACKGROUND OF INVENTION

Nano materials refer to materials whose structural units have a size ranging from 1 nm to 100 nm. Since its size is already close to the coherent length of electrons, the properties of nano materials change greatly due to the self-organization caused by strong coherence. Moreover, since the size of nano materials is close to the wavelength of light, they have volume effect, surface effect, quantum size effect, and macroscopic quantum tunneling effect, and the like, and have unique characteristics of melting point, magnetism, optics, thermal conductivity, and electrical conductivity, thereby having important application value in a lot of fields.

Quantum Dots (QD) are a typical type of nano materials, which have characteristics such as small size and high energy conversion efficiency, and have a very important application prospect in fields such as illumination, display technology, solar cells, optical switches, sensing, and detection. Furthermore, quantum dots have the characteristics of high brightness, narrow emission, adjustable luminous color, good stability, and the like, which are in line with the development trend of ultra-thin, high brightness, high color gamut, and high color saturation in the field of display technology. Therefore, the quantum dots have become the most potential new materials for display technology in recent years.

The development of patterning techniques for nano materials such as quantum dots is of great value for their applications in the fields of light-emitting diode (LED), display technology, solar cells, optical switches, sensing and detection. Currently, the patterning technology of quantum dots mainly includes ink-jet printing and photolithography. In a photolithographic process, high-temperature heating, ultraviolet curing, and processing of developing solutions will all affect the stability of quantum dot composite microspheres. In the printing process, there is an extremely high requirement for the performance of printing ink, and there is no mature and stable material system to realize mass production. In addition, ink-jet printing quantum dots have poor repeatability, long preparation time and low processing accuracy, which cannot meet the needs of high pixels density devices. The above defects greatly restrict the development and application of quantum dots. A known new quantum dot patterning technology utilizes an electrodeposition method to process quantum dot patterned films. In this method, to avoid low photoluminescence efficiency of the quantum dot patterned film due to the self-absorption effect of quantum dot materials, studies have been conducted by coating materials such as silica, or the like on quantum dot microspheres. In this way, the occurrence of the self-absorption effect of quantum dot materials can be avoided by the spacing of the added shell, thereby improving the luminous efficiency of the prepared quantum dot films. Meanwhile, studies have also been conducted by adding polymers to quantum dot microspheres coated by materials such as silica, or the like to avoid problems such as poor morphology of the patterns prepared by electrodeposition method, and cracking of the prepared quantum dot films. However, the polymers can be simultaneously deposited on the positive electrode and the negative electrode during the electrodeposition process, which causes problems in preparing multi-color quantum dot patterns.

Therefore, the related arts still need to be improved and developed.

### SUMMARY OF INVENTION

An object of the present disclosure is to provide quantum dot composite microspheres and quantum dot composite microsphere films and preparation method thereof, aiming to solve a certain extent the technical problem of poor effect of preparing multi-color quantum dot patterns caused by the fact that existing quantum dot microspheres are simultaneously deposited on a positive electrode and a negative electrode during an electrodeposition process.

In a first aspect, some embodiments of the present disclosure provide a quantum dot composite microsphere, which includes a core, a quantum dot layer adsorbed on a surface of the core, and an outer shell layer coated on the surface of the quantum dot layer, wherein one or more polymer ligands with an ionizable end group are attached to the surface of the outer shell layer.

In some embodiments of the present disclosure, the ionizable end group is one or more of an amino group, a carboxyl group, a sulfhydryl group, a hydroxyl group, a carbonyl group, or a siloxy group.

In some embodiments of the present disclosure, a relative molecular mass of the polymer ligand ranges from 200 to 5000.

In some embodiments of the present disclosure, the quantum dots in the quantum dot layer are selected from at least one of a single-structured quantum dot, a core-shell structured quantum dot, a perovskite quantum dot, or a composite quantum dot.

In some embodiments of the present disclosure, the single-structured quantum dot is selected from at least one of ZnCdSe₂, InP, Cd₂SSe, CdSe, Cd₂SeTe and InAs.

The core-shell structured quantum dot comprises a light-emitting core and a protective layer covering the light-emitting core, the light-emitting core is selected from at least one of ZnCdSe₂, InP, Cd₂SSe, CdSe, Cd₂SeTe, and InAs, and the protective layer is selected from at least one of CdS, ZnSe, ZnCdS₂, ZnS, and ZnO.

The perovskite quantum dot is selected from at least one of CsPbCl₃, CsPbBr₃ and CsPbI₃.

The composite quantum dot is selected from one of a quantum dot loaded a hydrogel structure or CdSe—SiO₂

In some embodiments of the present disclosure, a material of both the core and the outer shell layer is selected from an inorganic material or an organic material.

In some embodiments of the present disclosure, the inorganic material is at least one of silica, zinc oxide, aluminum oxide, zirconium oxide, barium sulfate, or titanium dioxide, and the organic material is polystyrene or polymethyl methacrylate.

In some embodiments of the present disclosure, a diameter of the quantum dot composite microsphere ranges from 60 nm to 400 nm.

In some embodiments of the present disclosure, a diameter of the core ranges from 30 nm to 150 nm; and/or
a diameter of the quantum dot in the quantum dot layer ranges from 10 nm to 20 nm; and/or
a thickness of the outer shell layer ranges from 10 nm to 50 nm.

In a second aspect, embodiments of the present disclosure provide a quantum dot composite microsphere film including the above-mentioned quantum dot composite microspheres.

In a third aspect, embodiments of the present disclosure provide a method for preparing the quantum dot composite microsphere film including steps of:
providing an organic solvent with quantum dot composite microspheres dispersed therein; and
coating the organic solvent with quantum dot composite microspheres dispersed therein on a patterned electrode substrate, and obtaining the quantum dot composite microsphere film by electrodeposition.

According to the quantum dot composite microspheres provided by the present disclosure, polymer ligands are disposed on an outer shell layer of quantum dot composite microspheres, and the polymer ligands are provided with ionizable end groups. After the quantum dot composite microspheres are dissolved in a solvent, the ionizable end groups on the polymer ligands enable the quantum dot composite microsphere to be charged positively or negatively, which is beneficial to the subsequent preparation of multi-color quantum dot patterns by electrodeposition. Further, due to high relative molecular mass of the polymer ligands, a compact and uniform film can be obtained, so that the technical problem of cracking of the prepared quantum dot composite microsphere films can be avoided, and multi-color quantum dot patterns with high precision, high efficiency and good morphology can be obtained.

### BRIEF DESCRIPTION OF THE DRAWINGS

In order to more clearly describe the technical solutions in embodiments of the present disclosure, hereinafter, the appended drawings used for describing the embodiments in the present disclosure will be briefly introduced. Apparently, the appended drawings described below are only directed to some embodiments of the present disclosure, and for a person skilled in the art, without expenditure of creative labor, other drawings can be derived on the basis of these appended drawings.

FIG. 1 is a schematic structural diagram of a quantum dot composite microsphere according to some embodiments of the present disclosure.

FIG. 2 is a schematic process diagram for preparing quantum dot composite microspheres according to some embodiments of the present disclosure.

FIG. 3 is a schematic flow diagram of electrodeposition according to some embodiments of the present disclosure.

FIG. 4 is a schematic structural diagram of an electrode substrate according to some embodiments of the present disclosure.

FIG. 5 is a schematic structural diagram of a red-green color conversion layer array structure prepared based on quantum dot composite microspheres according to some embodiments of the present disclosure.

FIG. 6 is a schematic structural diagram of a red-green color conversion layer array structure prepared based on quantum dots according to some embodiments of the present disclosure.

FIG. 7 is a scanning electron microscope diagram of quantum dot composite microspheres according to some embodiments of the present disclosure.

### EMBODIMENTS OF INVENTION

Hereinafter, technical solutions in embodiments of the present disclosure will be clearly and completely described with reference to the accompanying drawings in embodiments of the present disclosure. Obviously, the described embodiments are part of, but not all of, the embodiments of the present disclosure. All the other embodiments, obtained by a person with ordinary skill in the art on the basis of the embodiments in the present disclosure without expenditure of creative labor, belong to the protection scope of the present disclosure. In addition, it should be understood that specific embodiments described herein are only used to illustrate and explain the present disclosure, and are not intended to limit the present disclosure.

In description of the present disclosure, it should be understood that the terms such as the terms “first” and “second” are used for descriptive purposes only and cannot be understood as indicating or implying relative importance or implying a number of the indicated technical features. Therefore, the features defined as “first” and “second” can explicitly or implicitly include one or more of these features. In the description of the present disclosure, “a plurality of” means two or more, unless otherwise specifically defined.

The weight of the related components mentioned in the specification of the embodiments of the present disclosure may refer not only to the specific content of each component, but also indicate the proportional relationship of the weight of each component, so as long as the content of related components is scaled up or down according to the specification of the embodiments of the present disclosure, it is within the scope disclosed in the specification of the embodiments of the present disclosure. Specifically, the weight described in the specification of the embodiments of the present disclosure may be a mass unit known in the chemical field such as ug, mg, g, and kg.

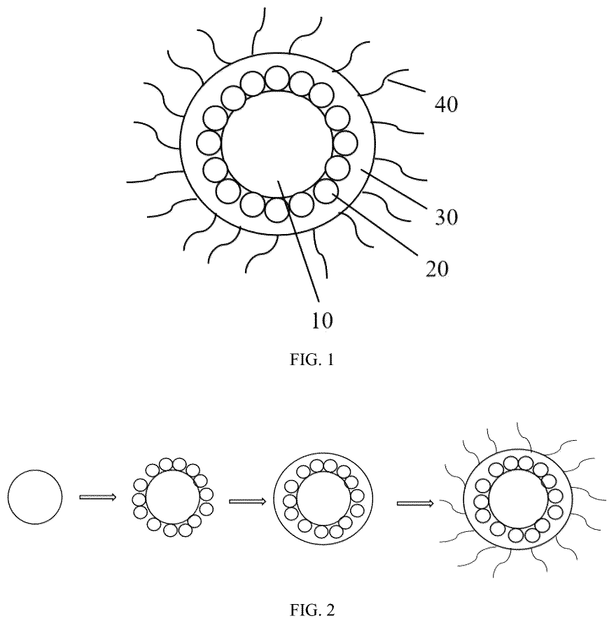

As shown in FIG. 1, some embodiments of the present disclosure provide a quantum dot composite microsphere, which includes a core 10, a quantum dot layer 20 adsorbed on a surface of the core 10, and an outer shell layer 30 coated on the surface of the quantum dot layer 20, wherein a plurality of polymer ligands 40 with ionizable end groups are attached to the surface of the outer shell layer 30.

In this embodiment, the quantum dot composite microsphere is a sandwich-structured quantum dot composite microsphere, wherein the quantum dot layer 20 is coated with the outer shell layer 30, which can effectively reduce the self-absorption of the quantum dots in the quantum dot layer 20, thereby improving the luminous efficiency of the quantum dot layer 20. Meanwhile, the outer shell layer 30 can effectively prevent water and oxygen from eroding the quantum dot layer 20, thereby improving the stability of the prepared quantum dot composite microsphere.

Furthermore, the quantum dot composite microsphere provided in this embodiment further includes the polymer ligands 40 disposed on the outer shell layer 30. The polymer ligands 40 have ionizable end groups. After the quantum dot composite microspheres are dissolved in a polar solvent, for example, ethanol, propylene glycol methyl ether acetate, dimethyl formamide, dimethyl sulfoxide, ethyl acetate, and the like, the ionizable end groups on the polymer ligands 40 are ionized, so that the quantum dot composite microsphere are capable of being charged positively or negatively. Since the quantum dot composite microspheres are charged either positively or negatively, the quantum dot composite microspheres are deposited on a positive electrode or a negative electrode during the electrodeposition process, which is beneficial to the subsequent preparation of multi-color quantum dot patterns by electrodeposition. Further, due to high relative molecular mass of the polymer ligands, the polymer ligands 40 are filled among the quantum dot composite microspheres in the quantum dot composite microsphere film obtained by electrodeposition, thus obtaining a compact and uniform film, so that the technical problem of cracking of the prepared quantum dot composite microsphere films can be avoided, and multi-color quantum dot patterns with high precision, high efficiency and good morphology can be obtained.

Understandably, in this embodiment, if the quantum dot composite microsphere includes only a core 10, a quantum dot layer 20 adsorbed on a surface of the core 10, and an outer shell layer 30 coated on the surface of the quantum dot layer 20, and the outer shell layer 30 is not modified with ligands, in the process of preparing the quantum dot composite microsphere film by electrodeposition, the adhesion between the quantum dot composite microspheres and the electrode is weak, and the quantum dot composite microspheres are easy to fall off from the electrode. Further, since the prepared quantum dot composite microsphere film is only formed by stacking a plurality of the quantum dot composite microspheres, there are inevitably a plurality of gaps and cracks, which leads to poor performance of the prepared quantum dot composite microsphere film.

Exemplarily, the ionizable end group is one or more of an amino group, a carboxyl group, a sulfhydryl group, a hydroxyl group, a carbonyl group, or a siloxy group.

In this embodiment, the ionizable end group is one or more of an amino group, a carboxyl group, a sulfhydryl group, a hydroxyl group, a carbonyl group, or a siloxy group, and the polymer ligand may be selected from materials with the above ionizable end group, for example polyethylene glycol (PEG), polyphenol, polyacrylamide, polyvinyl alcohol, or the like.

In this embodiment, since the polymer ligands carry the ionizable end groups, after the quantum dot composite microspheres are dispersed in a solution, the polymer ligands connected to the shell layer enable the quantum dot composite microspheres to be charged positively or negatively. For example, when the end group of the polymer ligand is a carboxyl group, a hydroxyl group, or a sulfhydryl group, the quantum dot composite microspheres are negatively charged when dispersed in propylene glycol methyl ether acetate (PGMEA) or dimethylformamide (DMF), while when the end group of the polymer ligand is an amino group, the quantum dot composite microspheres are positively charged when dispersed in ethanol.

Further, the relative molecular mass of the polymer ligand ranges from 200 to 5000.

In this embodiment, the higher the relative molecular mass of the polymer ligand, the longer the molecular chain of the polymer ligand, and the length of the molecular chain of the polymer ligand will affect the dispersibility of the quantum dot composite microspheres. If the relative molecular mass of the polymer ligand is too high, the dispersibility of the quantum dot composite microsphere will become poor, thereby affecting the performance of the quantum dot composite microsphere film prepared by the quantum dot composite microspheres. If the relative molecular mass of the polymer ligand is too low, a plurality of gaps and cracks will be formed in the quantum dot composite microsphere film prepared by the quantum dot composite microspheres, and the performance of the prepared quantum dot composite microsphere film will become poor. Therefore, in this embodiment, the polymer ligand with a relative molecular mass ranging from 200 to 5000 is selected to modify the outer shell layer of the quantum dot composite microsphere.

In case that the polymer ligand is Silane-PEG-COOH, the relative molecular mass of PEG in the polymer ligand is optionally from 400 to 3000.

Further, the quantum dots in the quantum dot layer are selected from at least one of a single-structured quantum dot, a core-shell structured quantum dot, a perovskite quantum dot, or a composite quantum dot.

Exemplarily, in this embodiment, the single-structured quantum dot is selected from at least one of ZnCdSe₂, InP, Cd₂SSe, CdSe, Cd₂SeTe and InAs. The core-shell structured quantum dot comprises a light-emitting core and a protective layer covering the light-emitting core, the light-emitting core is selected from at least one of ZnCdSe₂, InP, Cd₂SSe, CdSe, Cd₂SeTe, and InAs, and the protective layer is selected from at least one of CdS, ZnSe, ZnCdS₂, ZnS, and ZnO. The perovskite quantum dot is selected from at least one of CsPbCl₃, CsPbBr₃ and CsPbI₃. The composite quantum dot is selected from one of a quantum dot loaded a hydrogel structure or CdSe—SiO₂. It can be understood that the quantum dots in the quantum dot layer used in the present disclosure are not limited to the above types, and that the quantum dots in the quantum dot layer may be changed according to the actual situations.

It can be understood that in this embodiment, the quantum dots in the quantum dot layer may be red quantum dots, green quantum dots, or blue quantum dots. Core-shell structured quantum dots are taken as examples here, if the light-emitting core of the core-shell structured quantum dot is selected from one or more of InAs, CdSe, and Cd₂SeTe, and the protective shell is selected from one or more of CdS, ZnSe, ZnCdS₂, ZnS, and ZnO, the core-shell structured quantum dot is a red quantum dot. If the light-emitting core of the core-shell structured quantum dot is selected from one or more of ZnCdSe₂, InP, and Cd₂SSe, and the protective shell is selected from one or more of CdS, ZnSe, ZnCdS₂, ZnS, and ZnO, the core-shell structured quantum dot a green quantum dot.

Further, in this embodiment, the a material of both the core and the outer shell layer is selected from an inorganic material or an organic material, wherein the inorganic material is at least one of silica, zinc oxide, aluminum oxide, zirconium oxide, barium sulfate, or titanium dioxide, and the organic material is polystyrene or polymethyl methacrylate.

It should be noted that, in this embodiment, the material of the core and the material of the outer shell layer may be the same or different and are not further defined herein.

Furthermore, in this embodiment, the diameter of the quantum dot composite microsphere ranges from 60 nm to 400 nm.

Understandably, in this embodiment, the diameter of the quantum dot composite microsphere is related to the thickness of the prepared quantum dot composite microsphere film. If the diameter of the quantum dot composite microsphere is too large, the thickness of the prepared quantum dot composite microsphere film may also be too large, while if the diameter of the quantum dot composite microsphere is too small, the performance of the prepared quantum dot composite microsphere film may be unstable. Optionally, the diameter of the quantum dot composite microsphere may range from 200 nm to 300 nm.

In some embodiments of the present disclosure, the diameter of the core ranges from 30 nm to 150 nm; and/or the diameter of the quantum dot in the quantum dot layer ranges from 10 nm to 20 nm; and/or the thickness of the outer shell layer ranges from 10 nm to 50 nm.

In this embodiment, the quantum dot composite microsphere has a sandwich structure, and a plurality of quantum dots in the quantum dot layer as an intermediate layer are adsorbed on the surface of the core. If the size of the outer shell layer is too large, that is, the proportion of the outer shell layer is too large, the content of the quantum dots in the quantum dot composite microsphere will be low. If the size of the outer shell layer is too small, distances among the quantum dots in different quantum dot composite microspheres will be too small, so that light emitted by the quantum dots in the quantum dot composite microsphere will be absorbed by the quantum dots in other quantum dot composite microspheres, and the luminous efficiency of the prepared quantum dot composite microsphere film will be reduced.

Understandably, if the size of the core is too small, the number of quantum dots adsorbed will be small, that is, the number of quantum dots in the formed quantum dot layer will be low, which will result in low luminous efficiency of the quantum dot composite microspheres. However, if the size of the core is too large, the size of the quantum dot composite microsphere will be too large, which will directly affect the film-forming uniformity of the prepared quantum dot composite microsphere film.

In this embodiment, optionally, when the diameter of the core ranges from 30 nm to 150 nm, the diameter of the quantum dot in the quantum dot layer ranges from 10 nm to 20 nm, and the thickness of the outer shell layer ranges from 10 nm to 50 nm, the quantum dot composite microsphere film prepared by the quantum dot composite microspheres has high luminous efficiency, stable properties, and is not easy to crack.

As shown in FIG. 2, this embodiment further provides a method for preparing quantum dot composite microspheres, and the method includes: (1) providing a core; (2) adsorbing a layer of quantum dots on a surface of the core to form a quantum dot layer; (3) coating an outer shell on a surface of the quantum dot layer to form an outer shell layer; (4) attaching one or more polymer ligands to the outer shell layer.

The material of both the core and the outer shell layer is selected from an inorganic material or an organic material, wherein the inorganic material is at least one of silica, zinc oxide, aluminum oxide, zirconium oxide, barium sulfate, or titanium dioxide, and the organic material is polystyrene or polymethyl methacrylate.

The quantum dots in the quantum dot layer are selected from at least one of single-structured quantum dots, core-shell structured quantum dots, perovskite quantum dots, or composite quantum dots. The single-structured quantum dots are selected from at least one of ZnCdSe₂, InP, Cd₂SSe, CdSe, Cd₂SeTe and InAs. Each of the core-shell structured quantum dot includes a light-emitting core and a protective layer covering the light-emitting core, wherein the light-emitting core is selected from at least one of ZnCdSe₂, InP, Cd₂SSe, CdSe, Cd₂SeTe, and InAs, and the protective layer is selected from at least one of CdS, ZnSe, ZnCdS₂, ZnS, and ZnO. The perovskite quantum dots are selected from at least one of CsPbCl₃, CsPbBr₃ and CsPbI₃. The composite quantum dots are selected from one of hydrogel-loaded quantum dot structures or CdSe—SiO₂. It can be understood that the quantum dots in the quantum dot layer used in the present disclosure are not limited to the above types, and that the quantum dots in the quantum dot layer may be changed according to the actual situations.

In another aspect, this embodiment provides a quantum dot composite microsphere film including the above quantum dot composite microspheres.

Furthermore, this embodiment further provides a method for preparing a quantum dot composite microsphere film, which includes:
S10, providing an organic solvent with quantum dot composite microspheres dispersed therein; and
S20, coating the organic solvent with quantum dot composite microspheres dispersed therein on a patterned electrode substrate, and obtaining the quantum dot composite microsphere film by electrodeposition.

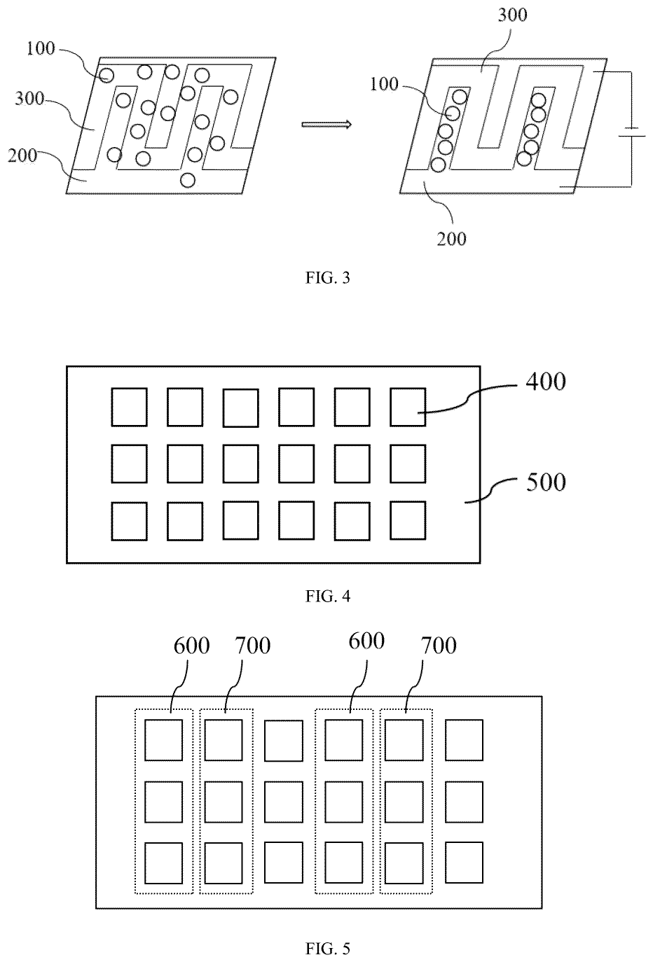

Exemplarily, in this embodiment, as shown in FIG. 3, the quantum dot composite microsphere film can be prepared by quantum dot composite microspheres 100 through electrodeposition. That is, the quantum dot composite microspheres 100 that are charged can be driven by an electric field to move onto an electrode 200 that has an opposite electrical property to the charged quantum dot composite microspheres 100, so that the quantum dot composite microspheres 100 are gathered and deposited on the electrode 200. The electrode 200 is an electrode disposed on a substrate 300.

In this embodiment, the quantum dot composite microspheres 100 are firstly dispersed in a colorless, transparent, low-boiling, volatile organic/inorganic reagent to obtain a solution with the quantum dot composite microspheres 100 dispersed therein. Then, the solution with the quantum dot composite microspheres 100 dispersed therein is scraped or dropped onto a substrate 300 with a patterned electrode 200 to form a uniform film of the quantum dot composite microspheres. Further, a specific voltage (0V to 1000V) is applied to the electrode 200 to form a vertical or horizontal electric field. Under the action of the electric field (with an electric field strength of 0V/um to 20V/um), the quantum dot composite microspheres 100 are moved to a target electrode. The target electrode is an electrode with an opposite charge to that of the quantum dot composite microspheres 100. If the quantum dot composite microspheres 100 are positively charged, negative charges are applied to the target electrode, while if the quantum dot composite microspheres 100 are negatively charged, positive charges are applied to the target electrode.

The material of the electrode is selected from indium tin oxide (ITO), a graphene, a metal, a transition metal sulfide (e.g., MoS₂, MoSe₂, WS₂, WSe₂, etc.), and the material of the substrate is selected from glass or an insulating film material.

In order to make the above-mentioned implementation details and operations of the present disclosure clearly understood by those skilled in the art, the above-mentioned technical solutions are illustrated below through specific examples.

### EXAMPLES

### (1) Preparation of Quantum Dot Composite Microspheres PS@CdSe/ZnS@SiO₂:

Providing spherical polystyrene (PS) with a diameter of 150 nm, CdSe/ZnS quantum dots with a diameter of 10 nm, as well as amino ligands, carboxyl ligands and Silane-PEG-COOH.

Modifying the spherical polystyrene with amino ligands, and meanwhile modifying the CdSe/ZnS quantum dots with carboxyl ligands, then mixing spherical polystyrene modified by the amino ligands with the CdSe/ZnS quantum dots modified by the carboxyl ligands, so that the CdSe/ZnS quantum dots modified by the carboxyl ligands can be adsorbed onto the surface of the spherical polystyrene modified by the amino ligands, thus obtaining PS@CdSe/ZnS microspheres.

Coating SiO₂ on the surface of PS@CdSe/ZnS microspheres to form a SiO₂ layer with a thickness of 50 nm, then modifying SiO₂ with Silane-PEG-COOH to obtain quantum dot composite microspheres PS@CdSe/ZnS@SiO₂.

Preparation of Quantum Dot Composite Microspheres PS@Cd₂SSe/ZnS@SiO₂:

Providing spherical polystyrene (PS) with a diameter of 150 nm, Cd₂SSe/ZnS quantum dots with a diameter of 10 nm, as well as amino ligands, carboxyl ligands and Silane-PEG-COOH.

Modifying the spherical polystyrene with amino ligands, and meanwhile modifying the Cd₂SSe/ZnS quantum dots with carboxyl ligands, then mixing spherical polystyrene modified by the amino ligands with the Cd₂SSe/ZnS quantum dots modified by the carboxyl ligands, so that the Cd₂SSe/ZnS quantum dots modified by the carboxyl ligands can be adsorbed onto the surface of the spherical polystyrene modified by the amino ligands, thus obtaining PS@Cd₂SSe/ZnS microspheres.

Coating SiO₂ on the surface of PS@Cd₂SSe/ZnS microspheres to form a SiO₂ layer with a thickness of 50 nm, then modifying SiO₂ with Silane-PEG-COOH to obtain quantum dot composite microspheres PS@Cd₂SSe/ZnS@SiO₂.

### (3) Patterning by Electrodeposition:

Dispersing the prepared quantum dot composite microspheres PS@CdSe/ZnS@SiO₂ in DMF to obtain a first microsphere solution with a concentration of 50 mg/ml, and dispersing the prepared quantum dot composite microspheres PS@Cd₂SSe/ZnS@SiO₂ in DMF to obtain a second microsphere solution with a concentration of 50 mg/ml.

Subjecting the first microsphere solution and the second microsphere solution to patterning by electrodeposition through the patterned electrode substrate shown in FIG. 4 to obtain a red-green color conversion layer array structure as shown in FIG. 5, wherein the electrode substrate includes a plurality of transparent electrodes 400 and a barrier structure 500 that are arranged in an array. The quantum dot composite microspheres PS@CdSe/ZnS@SiO₂ are red quantum dot composite microspheres, and the quantum dot composite microspheres PS@Cd₂SSe/ZnS@SiO₂ are green quantum dot composite microspheres. The electrode substrate includes a region 600 for depositing red quantum dot composite microspheres and a region 700 for depositing green quantum dot composite microspheres. The resolution of the color conversion layer array structure is 1200 PPI.

### Comparative Example

Providing quantum dots CdSe/ZnS with a diameter of 10 nm, and quantum dots Cd₂SSe/ZnS with a diameter of 10 nm. Dispersing the quantum dots CdSe/ZnS in DMF to obtain a first quantum dot solution with a concentration of 50 mg/ml, and meanwhile dispersing the quantum dots Cd₂SSe/ZnS in DMF to obtain a second quantum dot solution.

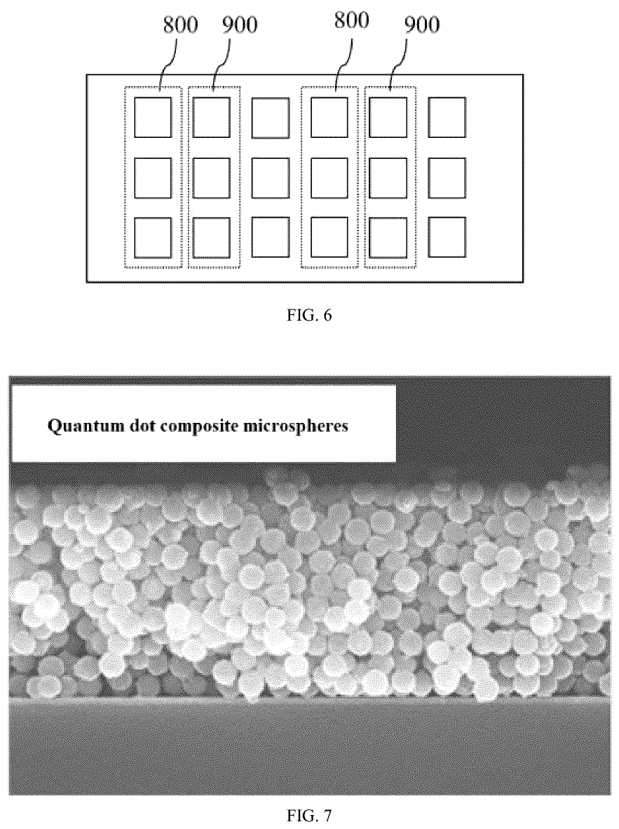

Subjecting the first microsphere solution and the second microsphere solution to patterning by electrodeposition through the patterned electrode substrate shown in FIG. 4 to obtain a red-green color conversion layer array structure as shown in FIG. 6, wherein the electrode substrate includes a plurality of transparent electrodes 400 and a barrier structure 500 that are arranged in an array. The quantum dots CdSe/ZnS are red quantum dots, and the quantum dots Cd₂SSe/ZnS are green quantum dots. The electrode substrate includes a region 800 for depositing red quantum dots and a region 900 for depositing green quantum dots. The resolution of the color conversion layer array structure is 1200 PPI.

Thereafter, in this example, the morphology of the prepared quantum dot composite microspheres PS@CdSe/ZnS@SiO₂ is detected, and the results are shown in FIG. 7.

Meanwhile, the color conversion efficiencies (CCE) of the films prepared by patterning through electrodeposition in the Examples and Comparative Examples are detected, and the results are shown in the following table:

CCE = Luminous brightness/absorbed
light brightness

| | Quantum dot composite | Quantum |
|---|---|---|
| | microspheres | dots |
| RCCE | 166% | 35% |
| GCCE | 325% | 77% |

It can be seen from the detection results that the color conversion efficiency of the solution using the quantum dot composite microspheres is significantly improved compared to the solution using the quantum dots alone. Based on this, the preparation of a quantum dot pixel array with high-efficiency and high-resolution can be realized by using the quantum dot composite microspheres. Further, in this example, the prepared quantum dot pixel array is used in Micro-led display, and the obtained brightness luminance conversion efficiency is as follows:

| | Brightness | Brightness of |
|---|---|---|
| | conversion | 500PPI quantum dot |
| | efficiency | color film substrate |
| PS@CdSe/Zns@SiO₂ | 160% | 100 cd/m² |
| PS@Cd₂SSe/ZnS@SiO₂ | 300% | 250/m² |

It can also be seen from the brightness conversion efficiency obtained by detection that the preparation of a quantum dot pixel array with high-efficiency and high-resolution can be realized by using the quantum dot composite microspheres.

The principles and embodiments of the present disclosure are described by using specific examples herein. Descriptions of the above embodiments are merely intended to help understand the technical solutions and core ideas of the present disclosure. Meanwhile, a person with ordinary skill in the art should understand that various modifications may still be made to the embodiments and application scopes according to ideas of the present disclosure. In view of the above, the specification should not be construed as limiting the present disclosure.

What is claimed is:

1. A quantum dot composite microsphere comprising a core, a quantum dot layer adsorbed on a surface of the core, and an outer shell layer coated on the surface of the quantum dot layer, wherein one or more polymer ligands with an ionizable end group are attached to the surface of the outer shell layer.

2. The quantum dot composite microsphere according to claim 1, wherein the ionizable end group is one or more of an amino group, a carboxyl group, a sulfhydryl group, a hydroxyl group, a carbonyl group, or a siloxy group.

3. The quantum dot composite microsphere according to claim 1, wherein a relative molecular mass of the polymer ligand ranges from 200 to 5000.

4. The quantum dot composite microsphere according to claim 1, wherein the quantum dots in the quantum dot layer are selected from at least one of a single-structured quantum dot, a core-shell structured quantum dot, a perovskite quantum dot, or a composite quantum dot.

5. The quantum dot composite microsphere according to claim 4, wherein the single-structured quantum dot is selected from at least one of ZnCdSe₂, InP, Cd₂SSe, CdSe, Cd₂SeTe and InAs;
the core-shell structured quantum dot comprises a light-emitting core and a protective layer covering the light-emitting core, the light-emitting core is selected from at least one of ZnCdSe₂, InP, Cd₂SSe, CdSe, Cd₂SeTe, and InAs, and the protective layer is selected from at least one of CdS, ZnSe, ZnCdS₂, ZnS, and ZnO;
the perovskite quantum dot is selected from at least one of CsPbCl₃, CsPbBr₃ and CsPbI₃; and
the composite quantum dot is selected from one of a quantum dot loaded a hydrogel structure or CdSe—SiO₂.

6. The quantum dot composite microsphere according to claim 1, wherein a material of both the core and the outer shell layer is selected from an inorganic material or an organic material.

7. The quantum dot composite microsphere according to claim 6, wherein the inorganic material is at least one of silica, zinc oxide, aluminum oxide, zirconium oxide, barium sulfate, or titanium dioxide, and the organic material is polystyrene or polymethyl methacrylate.

8. The quantum dot composite microsphere according to claim 1, wherein a diameter of the quantum dot composite microsphere ranges from 60 nm to 400 nm.

9. The quantum dot composite microsphere according to claim 8, wherein a diameter of the core ranges from 30 nm to 150 nm; and/or
a diameter of the quantum dot in the quantum dot layer ranges from 10 nm to 20 nm; and/or
a thickness of the outer shell layer ranges from 10 nm to 50 nm.

10. The quantum dot composite microsphere according to claim 2, wherein a diameter of the quantum dot composite microsphere ranges from 60 nm to 400 nm.

11. The quantum dot composite microsphere according to claim 3, wherein a diameter of the quantum dot composite microsphere ranges from 60 nm to 400 nm.

12. The quantum dot composite microsphere according to claim 4, wherein a diameter of the quantum dot composite microsphere ranges from 60 nm to 400 nm.

13. A quantum dot composite microsphere film comprising a quantum dot composite microsphere, wherein the quantum dot composite microsphere comprises a core, a quantum dot layer adsorbed on a surface of the core, and an outer shell layer coated on the surface of the quantum dot layer, wherein one or more polymer ligands with an ionizable end group are attached to the surface of the outer shell layer.

14. The quantum dot composite microsphere film according to claim 13, wherein the ionizable end group is one or more of an amino group, a carboxyl group, a sulfhydryl group, a hydroxyl group, a carbonyl group, or a siloxy group.

15. The quantum dot composite microsphere film according to claim 13, wherein a relative molecular mass of the polymer ligand ranges from 200 to 5000.

16. The quantum dot composite microsphere film according to claim 13, wherein the quantum dots in the quantum dot layer are selected from at least one of a single-structured quantum dot, a core-shell structured quantum dot, a perovskite quantum dot, or a composite quantum dot.

17. The quantum dot composite microsphere film according to claim 16, wherein the single-structured quantum dot is selected from at least one of ZnCdSe₂, InP, Cd₂SSe, CdSe, Cd₂SeTe and InAs;
core-shell structured quantum dot comprises a light-emitting core and a protective layer covering the light-emitting core, the light-emitting core is selected from at least one of ZnCdSe₂, InP, Cd₂SSe, CdSe, Cd₂SeTe, and InAs, and the protective layer is selected from at least one of CdS, ZnSe, ZnCdS₂, ZnS, and ZnO;
the perovskite quantum dot is selected from at least one of CsPbCl₃, CsPbBr₃ and CsPbI₃; and
the composite quantum dot is selected from one of a quantum dot loaded a hydrogel structure or CdSe—SiO₂.

18. The quantum dot composite microsphere film according to claim 13, wherein a material of both the core and the outer shell layer is selected from an inorganic material or an organic material.

19. The quantum dot composite microsphere film according to claim 18, wherein the inorganic material is at least one of silica, zinc oxide, aluminum oxide, zirconium oxide, barium sulfate, or titanium dioxide, and the organic material is polystyrene or polymethyl methacrylate.

20. A method for preparing the quantum dot composite microsphere film according to claim 10, comprising steps of:
providing an organic solvent with quantum dot composite microspheres dispersed therein; and
coating the organic solvent with quantum dot composite microspheres dispersed therein on a patterned electrode substrate, and obtaining the quantum dot composite microsphere film by electrodeposition.
